(19) United States
(12) Patent Application Publication
(10) Pub. No.: US 2007/0045361 A1
(43) Pub. Date: Mar. 1, 2007

(54) Spare tire cover mounting structure

(75) Inventors: Hiroshi Aoyama, Okazaki-shi (JP); Hiroyasu Takeshita, Okazaki-shi (JP); Takeshi Nagase, Okazaki-shi (JP)

Correspondence Address: BIRCH STEWART KOLASCH & BIRCH, PO BOX 747, FALLS CHURCH, VA, 22040-0747, US

(73) Assignee: Mitsubishi Jidosha Kogyo Kabushiki Kaisha

(21) Appl. No.: 11/512,097

(22) Filed: Aug. 30, 2006

(30) Foreign Application Priority Data
Aug. 31, 2005 (JP) 2005-251982

(51) Int. Cl. B62D 43/00

(52) U.S. Cl. 224/42.2

(57) ABSTRACT

A spare tire cover mounting structure includes a spare tire cover and a locking unit. The spare tire cover covers a spare tire supported by an outer wall portion of a door member. The locking unit includes an engagement portion provided in the spare tire cover and a locking mechanism to be engaged with the engagement portion. The locking mechanism includes a member to be engaged to be engaged with the engagement portion and an operating portion to be operated for releasing the engagement between the engagement portion and member to be engaged. The operating portion is disposed inside the outer wall portion and at a position where it can be operated in a state where the door member is closed.

### BACKGROUND OF THE INVENTION

1. Field of the Invention

The present invention relates to a mounting structure of a spare tire cover for covering a spare tire.

2.Description of the Related Art

A vehicle such as a car is provided with a spare tire in order to respond to a tire blowout. The spare tire is mounted to the rear surface of a back door, for example.

In some cases, a license plate is attached to the back door of a car. Therefore, in this case, the spare tire is mounted to the back door at the position avoiding the license plate, e.g., a position displaced from the center of the back door in the car width direction.

In the case where the spare tire is mounted to the back door, the spare tire on the back door is protruded backward. Therefore, in the case where the spare tire is mounted to a position displaced from the center of the back door in the car width direction as described above, there is a possibility that the spare tire intrudes the illumination coverage area of a rear lamp mounted to the rear part of a car body.

Further, there is a possibility that the license plate is hidden by the spare tire depending on the visual angle. That is, visibility of the license plate may be decreased.

In order to cope with the above problem, a countermeasure of attaching the license plate to a spare tire cover for covering the spare tire which is mounted to the center of the back door in the car width direction has been taken.

With this countermeasure, it is possible to prevent the spare tire from intruding the illumination coverage area of the rear lamp. Further, since the license plate is attached to the spare tire cover, it is possible to prevent the visibility of the license plate from being decreased.

The configuration using the spare tire cover includes a system for preventing the spare tire from being stolen.

In this kind of the antitheft security system, the upper end of the spare tire cover is pivotably fixed to the car body by a hinge so as to be opened in the vertical direction. An operating portion to be used for releasing a lock state of a locking unit that fixes the spare tire to the car body is provided inside the lower end portion of the back door. This kind of system is disclosed in Jpn. Pat. Appln. Publication No. 11-192900.

However, since the operating portion is provided inside the lower end portion of the back door in the antitheft security system disclosed in Jpn. Pat. Appln. Publication No. 11-192900, the operating portion can be used only when the back door is opened.

In an open state, the back door is freely pivoted about the hinge shaft that connects the back door to the car body and thereby becomes unstable state.

Since the operating portion is operated in a state where the back door is opened as described above, the working efficiency may be decreased.

### BRIEF SUMMARY OF THE INVENTION

An object of the present invention is to provide a spare tire cover mounting structure capable of preventing a spare tire from being stolen and improving the efficiency of the operation for releasing a lock state achieved by a locking unit.

A spare tire cover mounting structure according to the present invention includes a spare tire cover, a locking unit, and an operating portion. The spare tire cover covers at least a part of a spare tire supported at the outside of a door member of a vehicle. The locking unit keeps a locked state where the spare tire cover covers the spare tire. The operating portion is operated for releasing the locked state kept by the locking unit. The operating portion is disposed inside an outer wall portion of the door member and at a position where it is configured to be operated from the inside of the vehicle in a state where the door member is closed.

In the spare tire cover mounting structure having the configuration as described above, the operating portion is configured to be operated from a passenger compartment side in a state where the door member is closed. In the closed state, the position of the door member is fixed. Therefore, the posture of the door member becomes stable when the operation portion is operated.

The operating portion is operated from the passenger compartment side in a state where the door member is closed and the posture thereof is stable, thereby preventing the spare tire from being stolen and improving the efficiency of the operation for releasing a lock state achieved by the locking unit.

In a preferred embodiment of the present invention, the door member includes an outer panel and an inner panel positioned inside the vehicle body with respect to the outer panel. The locking unit includes an engagement portion and a locking mechanism which is engaged with the engagement portion and keeps the engagement state. The engagement portion is provided in the spare tire cover. The locking mechanism is contained in a space defined between the inner panel and outer panel.

In the spare tire cover mounting structure having the configuration as described above, the locking mechanism is contained in the space provided between the outer panel and inner panel.

In a preferred embodiment of the present invention, the operating portion is contained in the space. A first operation through hole is formed in the inner panel. The first operation through hole is positioned such that the operating portion is configured to be operated from the inside of the vehicle.

In the spare tire cover mounting structure having the configuration as described above, the operating portion is configured to easily be operated from the inside of the vehicle.

In a preferred embodiment of the present invention, the spare tire cover mounting structure further includes a second operation through hole formed in a trim which is positioned inside the vehicle body with respect to the inner panel, and a cover member which covers the second operation through hole. The second operation through hole is positioned such that the operating portion is configured to be operated from the inside of the vehicle.

In the spare tire cover mounting structure having the configuration as described above, the operating portion is configured to easily be operated from the inside of the vehicle.

In a preferred embodiment of the present invention, the locking mechanism includes a member to be engaged which is engaged with the engagement portion and a housing which contains the member to be engaged and which is disposed in the space. The operating portion is disposed outside the housing.

In the spare tire cover mounting structure having the configuration as described above, the operating portion is configured to easily be operated from the inside of the vehicle.

In a preferred embodiment of the present invention, the engagement portion has a pair of first portions which are protruded from the spare tire cover side and a second portion which connects the leading ends of the first portions and is formed into U-like shape. The locking mechanism has a latch structure to be engaged with the second portion.

In the spare tire cover mounting structure having the configuration as described above, a structure of the locking unit is realized with simpler structure, because of the locking unit having the latch structure.

In a preferred embodiment of the present invention, the engagement portion is a bolt. The locking mechanism includes a screw nut engaged with the bolt.

The spare tire cover mounting structure having the configuration as described above is configured to be obtained with a simpler structure using the bolt and screw nut.

In a preferred embodiment of the present invention, the door member is a back door of the car.

In the spare tire cover mounting structure having the configuration as described above, even the back door can obtain the same advantage as above.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a rear surface view of a car to which a spare tire cover mounting structure according to a first embodiment of the present invention is applied;

FIG. 2 is a cross-sectional view of the car taken along F2-F2 line in FIG. 1;

FIG. 3 is a cross-sectional view showing an area surrounded by F3 in FIG. 2 in an enlarged manner;

FIG. 4 is a perspective view showing a locking unit shown in FIG. 2; and

FIG. 5 is a cross-sectional view showing the main part of a spare tire cover mounting structure according to a second embodiment of the present invention.

### DETAILED DESCRIPTION OF THE INVENTION

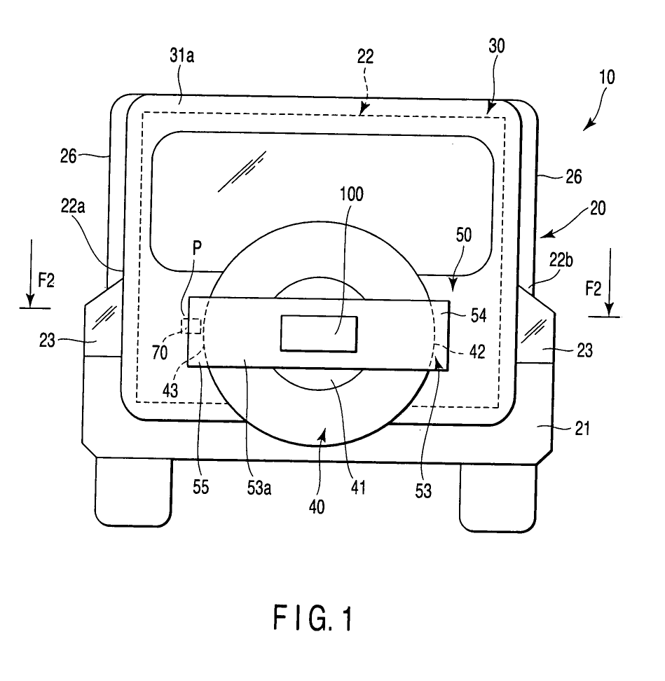

A spare tire cover mounting structure according to a first embodiment of the present invention will be described using FIGS. 1 to 4.

FIG. 1 is a rear surface view of a car 10 to which the spare tire cover mounting structure is applied. The car 10 corresponds to a vehicle defined in the present invention. As shown in FIG. 1, an opening 22, a pair of rear lamps 23, and the like are provided in a rear portion 21 of a car body 20 of the car 10. The opening 22 is denoted by a dotted line.

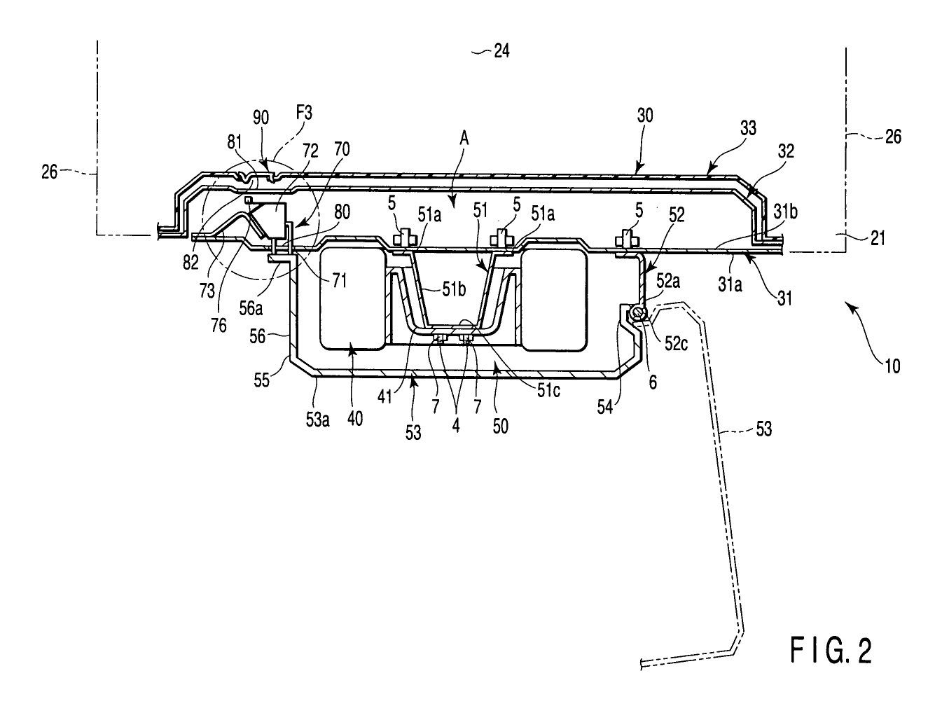

The opening 22 communicates with a luggage compartment and passenger compartment 24 (partly shown in FIG. 2). Each rear lamp 23 is provided at right and left edge portions of the openings in the car width direction, for example, respectively.

A back door 30 covering the opening 22 is provided at the rear portion 21 of the car body 20. The back door 30 constitutes a part of the car body 20.

FIG. 2 is a cross-sectional view taken along F2-F2 line of FIG. 1. As shown in FIG. 2, the back door 30 includes an outer panel 31, an inner panel 32, a door trim 33, and the like. The outer panel 31 is positioned at the outside of the car body 20. The inner panel 32 is positioned at the position inside the outer panel 31. The door trim 33 is positioned at the position inside the inner panel 32 and faces the passenger compartment 24. A space A is defined between the outer panel 31 and inner panel 32. The outer panel 31 corresponds to an outer wall portion defined in the present invention.

A side wall portion 26 of the car body 20 is denoted by a chain double-dashed line in FIG. 2. In FIG. 2, the back door 30 is in a closed state.

As shown in FIG. 1, the car 10 is provided with a spare tire 40. The spare tire 40 is mounted to an outer surface 31a of the back door 30 by a mounting mechanism 50. Note that the outer surface 31a of the back door 30 corresponds to the outer surface 31a of the outer panel 31.

As shown in FIG. 2, the mounting mechanism 50 includes a spare tire supporting portion 51, a spare tire cover 53, and a cover supporting portion 52, and a locking unit 70.

The spare tire supporting portion 51 is fixed to the outer panel 31 of the back door 30 so as to be protruded outward. The spare tire supporting portion 51 has a base portion 51a and a protrusion portion 51b. The protrusion portion 51b is protruded rearward from the outer surface 31a of the outer panel 31. The base portion 51a is for example continuously formed from the protrusion portion 51b and positioned at both ends thereof in the car width direction. The base portion 51a is fixed to the back door 30 by a fixing member such as a pin 5.

A plurality of bolts 4 are provided at the leading end of the protrusion portion 51b. The leading end of the protrusion portion 51b serves as a mounting seat 51c to which the spare tire 40 is fixed. When the bolts are inserted into and engaged with a wheel 41 of the spare tire 40 and fastened by a screw nut 7, the spare tire 40 is fixed to the spare tire supporting portion 51.

The spare tire 40 is hung on the protrusion portion 51b. Therefore, the protrusion portion 51b has a size small enough to fit inside the wheel 41 of the spare tire 40.

The spare tire 40 shown in FIG. 1 is fixed to the spare tire supporting portion 51. As shown in FIG. 1, in a state being fixed to the spare tire supporting portion 51, the spare tire 40 is disposed at substantially the center of the back door 30 in the car width direction and in the vertical direction of the car body 20.

The spare tire supporting portion 51 is fixed to the back door 30 such that the spare tire 40 is disposed at the above position. Accordingly, the spare tire supporting portion 51 is also fixed to the substantially the center of the back door 30 in the car width direction and in the vertical direction of the car body 20.

As a result, the spare tire 40 is disposed at such a position that does not interfere with the illumination coverage area of the rear lamps 23. Note that the position of the spare tire 40 is not limited to the above. The spare tire 40 may be disposed at any position as long as it does not interfere with the illumination coverage area of the rear lamps 23.

As shown in FIG. 2, the cover supporting portion 52 is fixed to the outer panel 31 of the back door 30 by a fixing member such as a pin 5. In a state where the spare tire 40 is mounted to the outer panel 31, that is, the spare tire 40 is fixed to the spare tire supporting portion 51, the cover supporting portion 52 is disposed outside the spare tire 40 in the car width direction. The cover supporting portion 52 extends rearward to the position near the rear end of the spare tire 40.

The spare tire cover 53 mounting structure includes the spare tire cover 53 and locking unit 70.

As shown in FIG. 1, the spare tire cover 53 has a size covering a part of the spare tire 40. Specifically, the spare tire cover 53 has a size enough to cover the area from one end portion 42 to the other end portion 43 of the spare tire 40 in the car width direction. In terms of the vertical direction, the spare tire cover 53 has a size covering the area near the center of the spare tire 40. The spare tire cover 53 entirely covers the mounting seat 51c.

Thus, when viewed from the rear side, the spare tire cover 53 has substantially a rectangular shape elongated in the car width direction. The spare tire cover 53 is disposed at substantially the center in the vertical direction. A license plate 100 is attached to a rear surface 53a of the spare tire cover 53.

As shown in FIG. 2, one end portion 54 of the spare tire cover 53 is pivotably supported in the car width direction by the cover supporting portion 52.

A shaft supporting portion 52a is provided at the rear end portion of the cover supporting portion 52. A shaft through hole 52c through which a rotation shaft 6 is vertically inserted is formed in the shaft supporting portion 52a. Similarly, a shaft supporting portion (not shown) is formed in one end portion 54 of the spare tire cover 53 and a shaft through hole through which the rotation shaft 6 is vertically inserted is formed in the shaft supporting portion formed on the spare tire cover 53.

The shaft supporting portion 52a of the cover supporting portion 52 and shaft supporting portion of the spare tire cover 53 are vertically fitted to each other. Then a rotation shaft 6 is inserted through the shaft supporting portion 52a of the cover supporting portion 52 and shaft supporting portion of the spare tire cover 53.

In this manner, the spare tire cover 53 is pivotably supported in the car width direction by the cover supporting portion 52, as denoted by a chain double-dashed dotted line of FIG. 2.

A vertical wall portion 56 is formed at the other end portion 55 of the spare tire cover 53. The other end portion 55 is the portion on the opposite side to the one end portion 54 in the spare tire cover 53.

In a state where the spare tire cover 53 is closed, that is, the spare tire cover 53 covers the spare tire 40, the vertical wall portion 56 extends in the longitudinal direction of the car body. In a state where the spare tire cover 53 covers the spare tire 40, a leading end 56a of the vertical wall portion 56 reaches near the back door 30.

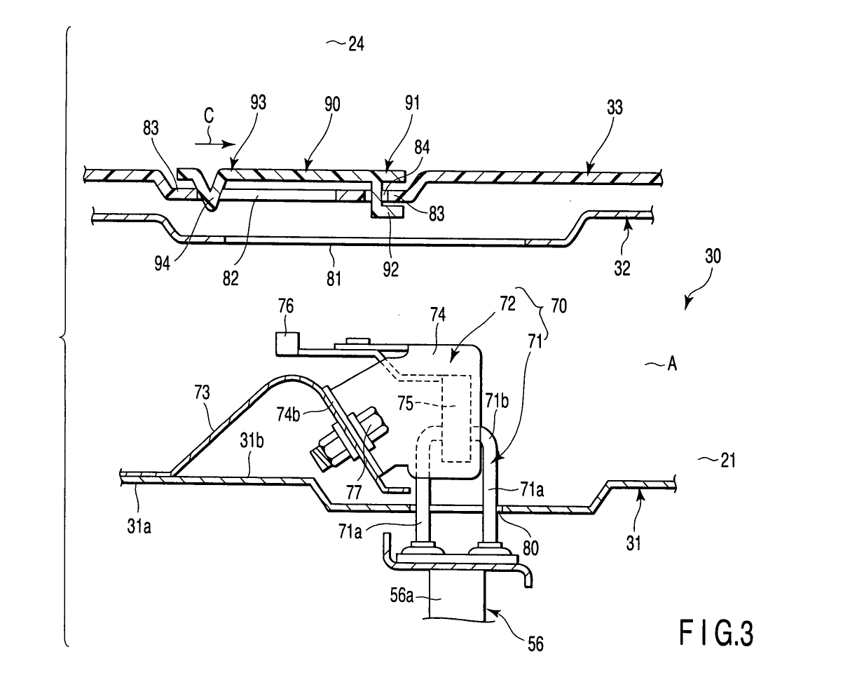

The locking unit 70 includes an engagement portion 71 and a locking mechanism 72. FIG. 3 is an enlarged view of an area F3 denoted by a circle shown in chain double-dashed dotted line in FIG. 2. As shown in FIGS. 2 and 3, the engagement portion 71 is provided at the leading end of the vertical wall portion 56. The engagement portion 71 has substantially a U-like shape as viewed from the above. The engagement portion 71 has a pair of first portions 71a extending in the longitudinal direction of the car body and a second portion 71b that connects the leading ends of the first portions 71a.

The first portions 71a of the engagement portion 71 have a length enough for the second portion 71b to enter the space A defined between the outer panel 31 and inner panel 32 in a state where the spare tire cover 53 covers the spare tire 40.

The locking mechanism 72 is fixed to the inner surface 31b of the outer panel 31 of the back door 30 through a locking unit reinforcing member 73.

The locking mechanism 72 has, e.g., a latch structure. The locking mechanism 72 includes a housing 74, a member to be engaged 75, a release lever 76, and the like.

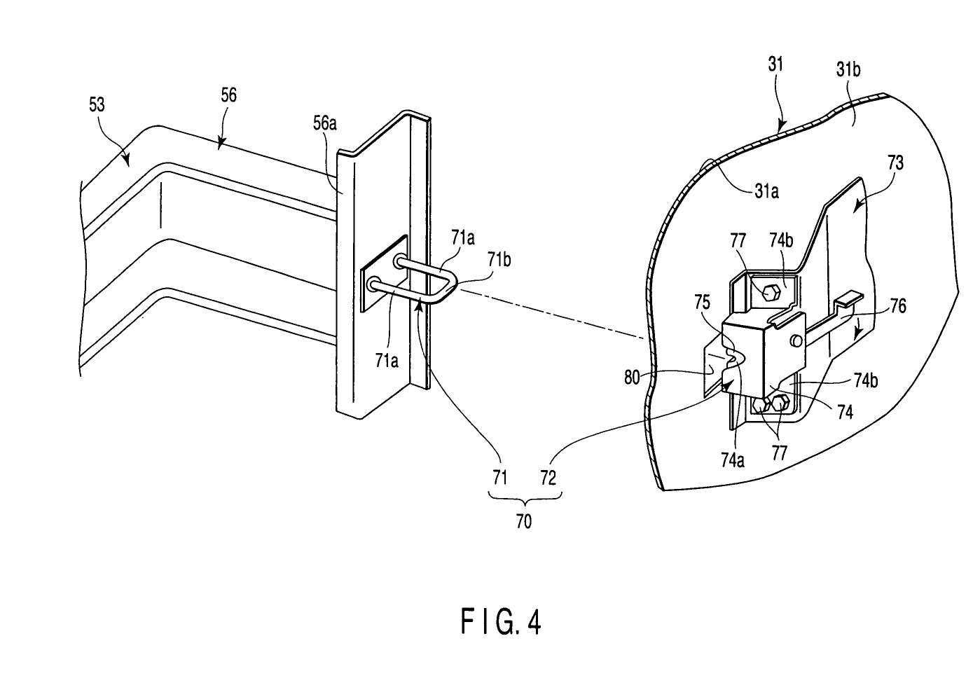

As denoted by a dotted line, a part of the second portion 71b of the engagement portion 71 enters the housing 74. FIG. 4 shows the locking unit 70. As shown in FIG. 4, the housing 74 has an opening 74a through which the second portion 71b of the engagement portion 71 passes.

A flange portion 74b is formed in the housing 74. The flange portion 74b is fixed to the locking unit reinforcing member 73 by bolts 77.

The member to be engaged 75 is supported by the housing 74 and is contained therein. When the second portion 71b of the engagement portion 71 enters the housing 74 through the opening 74a, the member to be engaged 75 is engaged with the second portion 71d, i.e., engagement portion 71. Thus, an engagement state between the member to be engaged 75 and engagement portion 71 is locked.

Therefore, in a state where the spare tire cover 53 is closed, that is, in a state where the spare tire cover 53 covers the spare tire 40 and the engagement portion 71 is engaged with the member to be engaged 75, the closed state of the spare tire cover 53 is maintained.

The release lever 76 protrudes from the housing 74. As shown in FIG. 3, the release lever 76 faces the inner panel 32 of the back door 30. By depressing the release lever 76, the engagement state between the engagement portion 71 and locking mechanism 72 is released. The release lever 76 corresponds to an operating portion defined in the present invention.

As shown in FIG. 1, the locking unit 70 having the configuration as described above is disposed in a position P near the center of the back door 30 in the vertical direction. The position P is a position where a passenger can operate the release lever 76 from the passenger compartment 24 side.

As shown in FIGS. 3 and 4, a first through hole 80 through which the engagement portion 71 passes is formed in the outer panel 31 of the back door 30. As shown in FIGS. 2 and 3, in the inner panel 32 of the back door 30, a second through hole 81 is formed in the position facing the release lever 76. That is, the second through hole 81 is positioned such that the release lever 76 can be operated from the passenger compartment 24 side.

The second through hole 81 penetrates the inner panel 32 in the longitudinal direction of the car body. The second through hole 81 has a size enough for a passenger to operate the release lever 76 from the passenger compartment 24 side. The second through hole 81 corresponds to a first operation through hole defined in the present invention.

In the door trim 33, a third through hole 82 is formed in the position facing the second through hole 81. That is, the third through hole 82 is positioned such that the release lever 76 can be operated from the passenger compartment 24 side. The third through hole 82 penetrates the door trim 33 in the longitudinal direction of the car body. The third through hole 82 has a size enough for a passenger to operate the release lever 76 from the passenger compartment 24 side. The third through hole 82 corresponds to a second operation through hole defined in the present invention.

As shown in FIG. 3, a cover member 90 for covering the third through hole 82 is provided in the door trim 33. An engagement portion 92 is formed at one end portion 91 of the cover member 90 in the car width direction. The engagement portion 92 extends in the longitudinal direction of the car body. The leading end of the engagement portion 92 is bent substantially at right angles and then extends along the car width direction. Therefore, the engagement portion 92 has substantially an L-like shape as viewed from the above. A fourth through hole 84 with which the engagement portion 92 is engaged is formed in an edge portion 83 of the third through hole 82.

A spring portion 94 is formed at the other end portion 93 of the cover member 90 in the car width direction. Specifically, the spring portion 94 is bent in a V-shaped manner so as to be protruded backward. Therefore, the spring portion 94 has elasticity in the car width direction. When the cover member 90 thus formed is attached to the door trim 33, firstly the engagement portion 92 is inserted through the forth through hole 84. Then the spring portion 94 side is forced into the third through hole 82, and the spring portion 94 is pressed to the edge portion 83 of the third through hole 82 by the elasticity of the spring portion 94 itself. In this state, the cover member 90 is held by the door trim 33.

An operation of releasing a locked state between the engagement portion 71 and locking mechanism 72 will next be described. Firstly, a passenger removes the cover member 90 from the passenger compartment 24 side in a state where the back door 30 is closed. Specifically, as shown in FIG. 3, the passenger presses the spring portion 94 of the cover member 90 in the car width direction as denoted by an arrow C. When being pressed in the car width direction, the spring portion 94 is moved away from the edge portion 83 of the third through hole 82. In this state, the spring portion 94 side of the cover member 94 is pulled out of the third through hole 82. Then, the engagement portion 92 is pulled out of the fourth through hole 84. As a result, removal of the cover member 90 from the door trim 33 is completed.

After that, the passenger operates the release lever 76 through the third and second through holes 82 and 81. This allows the engagement between the engagement portion 71 and locking mechanism 72 to be released.

In the spare tire mounting structure having the configuration described above, the release lever 76 is operated from the inner panel 32 side through the second through hole 81 formed in the inner panel 32 of the back door 30 and third through hole 82 formed in the door trim 33.

Therefore, the passenger can operate the release lever 76 from the passenger compartment 24 side in a state where the back door 30 is closed.

Because the release lever 76 can be operated from the passenger compartment 24 side, it is possible to prevent the spare tire 40 from being stolen. Further, since the release lever 76 is operated in a state where the back door 30 is closed, that is, the posture of the back door 30 is fixed, the removal operation of the cover member 90 and operation of the release lever 76 are performed in a state where the posture of the back door 30 is stable, thereby improving the operation works.

Further, the second and third through holes 81 and 82 are formed in the position through which the passenger can operate the release lever 76, thereby facilitating the operation of the release lever 76.

Further, the third through hole 82 is covered by the cover member 90, thereby preventing the deterioration of the appearance of the door trim 33 which may be caused by the formation of the third through hole 82.

Further, the release lever 76 protrudes from the housing 74. This also facilitates the operation of the release lever 76.

Further, the spare tire cover 53 is provided in a door member such as the back door, and the locking mechanism 72 is contained in the space A defined between the inner panel 32 and outer panel 31.

That is, the locking mechanism 72 is contained in the existing space A, so that it is not necessary to make additional space for the locking mechanism 72. Since the locking mechanism 72 need not be provided in the passenger compartment 24, a reduction in the size of the passenger compartment 24 can be prevented. Further, since the locking mechanism 72 is not protruded outside the car body, deterioration of the appearance of the car 10 can be prevented. Further, the release lever 76 of the locking mechanism 72 is contained in the space A defined between the inner panel 32 and outer panel 31, preventing luggage inside the car from being brought into contact with the release lever 76 while the car is moving. This prevents unexpected release of the locking mechanism 72.

Further, the locking mechanism 72 is realized by a latch structure and therefore can be formed with a simpler structure.

Further, the spare tire cover 53 is provided in the back door 30, so that even the back door 30 can obtain the same advantage as above.

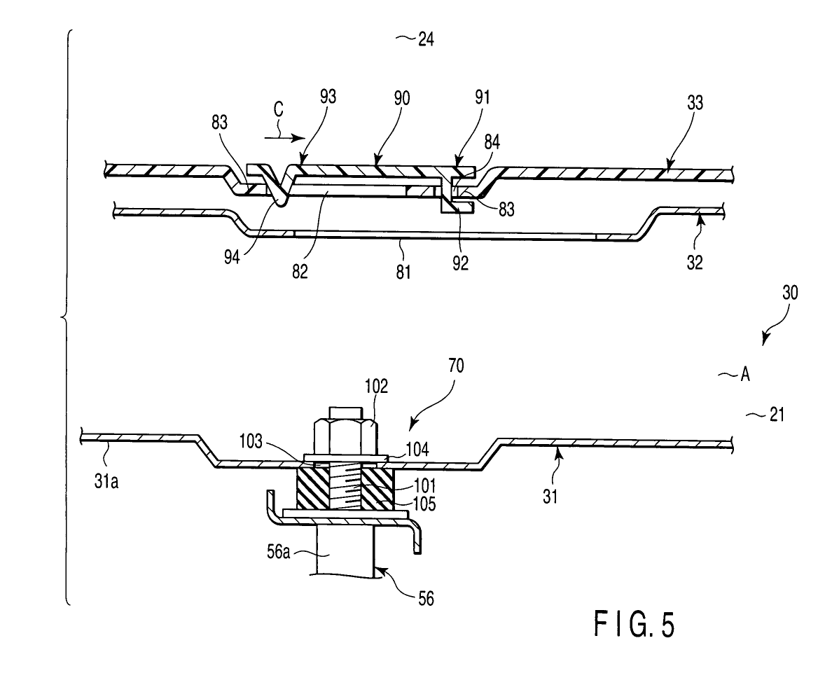

The spare tire cover mounting structure according to a second embodiment of the present invention will next be described using FIG. 5. In FIG. 5, the same reference numerals denote the same or corresponding parts as in the first embodiment, and the descriptions thereof will be omitted. The second embodiment may essentially be the same as the first embodiment except for the configuration of the locking unit 70. The different point in the configuration of the locking unit 70 will concretely be described.

FIG. 5 is a cross-sectional view showing the locking unit 70 according to the second embodiment. As shown in FIG. 5, the locking unit 70 according to the second embodiment includes a bolt 101, a screw nut 102, a washer 104, and a rubber bush 105.

The bolt 101 is fixed to the leading end of the vertical wall portion 56 of the spare tire cover 53. A bolt through hole 103 through which the bolt 101 is inserted is formed in the outer panel 31 of the back door 30. After the bolt 101 is inserted through the bolt through hole 103, the washer 104 is attached to the bottom of the bolt 101. The diameter of the bolt through hole 103 is smaller than that of the washer 104. After the attachment of the washer 104, the bolt 101 is engaged with the screw nut 102.

The engagement between the bolt 101 and screw nut 102 allows the spare tire cover 53 to be fixed to the car body 20 while covering the spare tire 40. The rubber bush 105 is provided around the bolt 101 and brought into contact with the outer panel 31 when the engagement between the bolt 101 and screw nut 102 is established. This stabilizes the posture of the spare tire cover 53 in a state where the spare tire cover 53 covers the spare tire 40.

The bolt 101 corresponds to an engagement portion defined in the present invention. The bolt through hole 103 and screw nut 102 correspond to a locking mechanism defined in the present invention. The screw nut 102 serves also as an operating portion defined in the present invention. That is, the screw not 102 is utilized as the operating portion to release the locked state of the bolt 101. The passenger fastens or loosens the screw nut 102 through the second through hole 81 and third through hole 82.

In the second embodiment, a locking unit can be obtained with a simpler structure using the bolt 101 and screw nut 102.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A spare tire cover mounting structure comprising:
a spare tire cover which covers at least a part of a spare tire supported at the outside of a door member of a vehicle;
a locking unit which keeps a locked state where the spare tire cover covers the spare tire; and
an operating portion which is operated for releasing the locked state kept by the locking unit, the operating portion being disposed inside an outer wall portion of the door member and at a position where it is configured to be operated from the inside of the vehicle in a state where the door member is closed.

2. The spare tire cover mounting structure according to claim 1, wherein
the door member comprises an outer panel and an inner panel positioned inside the vehicle body with respect to the outer panel, and
the locking unit comprises an engagement portion provided in the spare tire cover and a locking mechanism which is engaged with the engagement portion and keeps the engagement state, the locking mechanism being contained in a space defined between the inner panel and outer panel.

3. The spare tire cover mounting structure according to claim 2, wherein
the operating portion is contained in the space, and
a first operation through hole is formed in the inner panel, the first operation through hole being positioned such that the operating portion is configured to be operated from the inside of the vehicle.

4. The spare tire cover mounting structure according to claim 3, further comprising:
a second operation through hole formed in a trim which is positioned inside the vehicle body with respect to the inner panel, the second operation through hole being positioned such that the operating portion is configured to be operated from the inside of the vehicle; and
a cover member which covers the second operation through hole.

5. The spare tire cover mounting structure according to claim 3, wherein
the locking mechanism comprises an member to be engaged which is engaged with the engagement portion, and a housing which contains the member to be engaged and which is disposed in the space, and
the operating portion is disposed outside the housing.

6. The spare tire cover mounting structure according to claim 2, wherein
the engagement portion has a pair of first portions which are protruded from the spare tire cover side and a second portion which connects the leading ends of the first portions and is formed into U-like shape, and
the locking mechanism has a latch structure to be engaged with the second portion.

7. The spare tire cover mounting structure according to claim 2, wherein
the engagement portion is a bolt, and
the locking mechanism comprises a screw nut engaged with the bolt.

8. The spare tire cover mounting structure according to claim 1, wherein
the door member is a back door of the vehicle.
